(19) United States
(12) Patent Application Publication
(10) Pub. No.: US 2015/0346830 A1
(43) Pub. Date: Dec. 3, 2015

(54) CONTROL METHOD OF ELECTRONIC APPARATUS HAVING NON-CONTACT GESTURE SENSITIVE REGION

(71) Applicant: EMINENT ELECTRONIC TECHNOLOGY CORP. LTD., Hsinchu (TW)

(72) Inventors: TOM CHANG, Taipei City (TW); Kao-Pin Wu, New Taipei City (TW); Chih-Jen Fang, Tainan City (TW); Chan-Peng Lo, Taichung City (TW); Cheng-Ta Chuang, New Taipei City (TW)

(21) Appl. No.: 14/720,983

(22) Filed: May 26, 2015

Related U.S. Application Data
(60) Provisional application No. 62/004,912, filed on May 30, 2014.

(30) Foreign Application Priority Data
May 6, 2015 (TW) 104114390

(51) Int. Cl. G06F 3/01; G06F 3/0485; G06F 3/0483; G09G 5/18

(52) U.S. Cl. CPC G06F 3/017; G09G 5/18; G06F 3/0485; G06F 3/0483

(57) ABSTRACT

A control method of an electronic apparatus is provided. The electronic apparatus includes a display surface, and provides a gesture sensitive region near the display surface. The control method includes the following steps: determining motion information of a non-contact object around the electronic apparatus, wherein the non-contact object moves between an inside and an outside of the gesture sensitive region to generate the motion information; recognizing a non-contact gesture corresponding to the non-contact object according to the motion information; and enabling the electronic apparatus to perform a specific function according to the non-contact gesture.

### CROSS REFERENCE TO RELATED APPLICATIONS

This application claims the benefit of U.S. provisional application No. 62/004,912, filed on May 30, 2014, the contents of which are incorporated herein by reference.

### BACKGROUND OF THE INVENTION

1. Field of the Invention

The disclosed embodiments of the present invention relate to a non-contact gesture control mechanism, and more particularly, to a method for controlling an electronic apparatus according to motion information of a non-contact object which moves between an inside and an outside of a non-contact gesture sensitive region of the electronic apparatus.

2. Description of the Prior Art

A touch-based electronic apparatus provides a user with user-friendly interaction. However, it is inconvenient for the user to control the electronic apparatus when the user holds other objects in a user's hand (e.g. documents or drinks) or the user's hand is oily. For example, while eating French fries and reading an electronic book displayed on a screen of a tablet computer, the user prefers to turn pages of the electronic book without touching the screen using oily fingers.

Thus, a novel control mechanism is needed to allow the user to operate an electronic apparatus intuitively without touching it.

### SUMMARY OF THE INVENTION

It is therefore one objective of the present invention to provide a method for controlling an electronic apparatus according to motion information of a non-contact object which moves between an inside and an outside of a non-contact gesture sensitive region of the electronic apparatus, to solve the above-mentioned problems.

According to an embodiment of the present invention, an exemplary control method of an electronic apparatus is disclosed. The electronic apparatus comprises a display surface, and provides a gesture sensitive region near the display surface. The exemplary control method comprises the following steps: determining motion information of a non-contact object around the electronic apparatus, wherein the non-contact object moves between an inside and an outside of the gesture sensitive region to generate the motion information; recognizing a non-contact gesture corresponding to the non-contact object according to the motion information; and enabling the electronic apparatus to perform a specific function according to the non-contact gesture.

The proposed control method of an electronic apparatus cannot only provide non-contact human-computer interaction but also meet requirements of various and intuitive non-contact gestures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary electronic apparatus according to an embodiment of the present invention.

FIG. 2 illustrates an implementation of the optical sensor module shown in FIG. 1.

FIG. 3 is a diagram illustrating an exemplary electronic apparatus according to another embodiment of the present invention.

FIG. 4 is a front view of the electronic apparatus shown in FIG. 3.

FIG. 5 is a diagram illustrating control over the electronic apparatus shown in FIG. 3 according to an embodiment of the present invention.

FIG. 6 is a diagram illustrating control over the electronic apparatus shown in FIG. 3 according to another embodiment of the present invention.

FIG. 7 is a diagram illustrating control over the electronic apparatus shown in FIG. 3 according to another embodiment of the present invention.

FIG. 8 is a diagram illustrating control over the electronic apparatus shown in FIG. 3 according to another embodiment of the present invention.

FIG. 9 is a diagram illustrating control over the electronic apparatus shown in FIG. 3 according to another embodiment of the present invention.

FIG. 10 is a diagram illustrating control over the electronic apparatus shown in FIG. 3 according to another embodiment of the present invention.

FIG. 11 is a diagram illustrating control over the electronic apparatus shown in FIG. 3 according to another embodiment of the present invention.

FIG. 12 is a diagram illustrating control over the electronic apparatus shown in FIG. 3 according to another embodiment of the present invention.

FIG. 13 is a diagram illustrating control over the electronic apparatus shown in FIG. 3 according to another embodiment of the present invention.

FIG. 14 is an implementation of the gesture sensitive region of the electronic apparatus shown in FIG. 13.

FIG. 15 is another implementation of the gesture sensitive region of the electronic apparatus shown in FIG. 13.

FIG. 16 is a diagram illustrating control over the electronic apparatus shown in FIG. 3 according to another embodiment of the present invention.

FIG. 17 is a diagram illustrating control over the electronic apparatus shown in FIG. 3 according to another embodiment of the present invention.

FIG. 18 is a diagram illustrating control over the electronic apparatus shown in FIG. 3 according to another embodiment of the present invention.

FIG. 19 is a diagram illustrating control over the electronic apparatus shown in FIG. 3 according to another embodiment of the present invention.

FIG. 20 is a diagram illustrating control over the electronic apparatus shown in FIG. 3 according to another embodiment of the present invention.

FIG. 21 is a diagram illustrating control over the electronic apparatus shown in FIG. 3 according to another embodiment of the present invention.

FIG. 22 is a diagram illustrating control over the electronic apparatus shown in FIG. 3 according to another embodiment of the present invention.

### DETAILED DESCRIPTION

In order to provide intuitive and user-friendly non-contact human-computer interaction, the proposed non-contact control method may determine motion information (e.g. information associated with position and time, or a direction of movement) of a non-contact object which moves between an inside and an outside of a non-contact gesture sensitive region of an electronic apparatus, and define a non-contact gesture (an air gesture untouching the electronic apparatus) according to the motion information, thereby enabling the electronic apparatus to perform a corresponding function. In the following, the proposed non-contact control mechanism is described with reference to a multimedia playback apparatus capable of detecting a non-contact gesture. However, this is for illustrative purposes only. The proposed non-contact control mechanism may be employed in other types of electronic apparatuses capable of detecting a non-contact gesture.

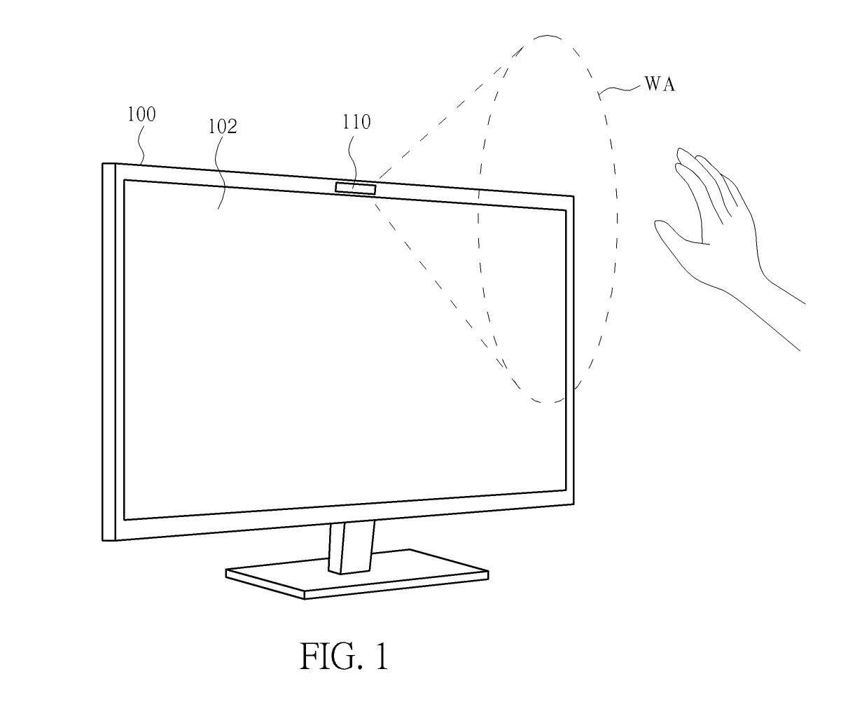

Please refer to FIG. 1, which is a diagram illustrating an exemplary electronic apparatus according to an embodiment of the present invention. In this embodiment, the electronic apparatus 100 is implemented by a multimedia playback apparatus (e.g. a video player), and may include a display surface 102. The user may perform a non-contact gesture around the electronic apparatus 100 (or the display surface 102) so as to enable the electronic apparatus 100 to perform a corresponding function. For example, the electronic apparatus 100 may include an optical sensor module 110, wherein the optical sensor module 110 may be disposed on an outer periphery of the display surface 102 (or a frame of the electronic apparatus 100) and provide a non-contact sensing region WA in front of the display surface 102 (facing the user). Hence, when a non-contact object is located within the non-contact sensing region WA (e.g. a user's hand located in front of the display surface 102), the electronic apparatus 100 may detect motion information of the non-contact object (e.g. a path or a direction of movement) and accordingly perform a corresponding function.

By way of example but not limitation, the optical sensor module 110 may emit at least one detection signal (a light signal) to the non-contact object, receive a plurality of reflected signals reflected from the non-contact object in response to the at least one detection signal, and determine the motion information (e.g. a path or a direction of movement) of the non-contact object according to the reflected signals. Hence, the non-contact sensing region WA may be an intersection of an illumination range (e.g. a light cone) and a light reception range (e.g. a sensor field of view) of the optical sensor module 110.

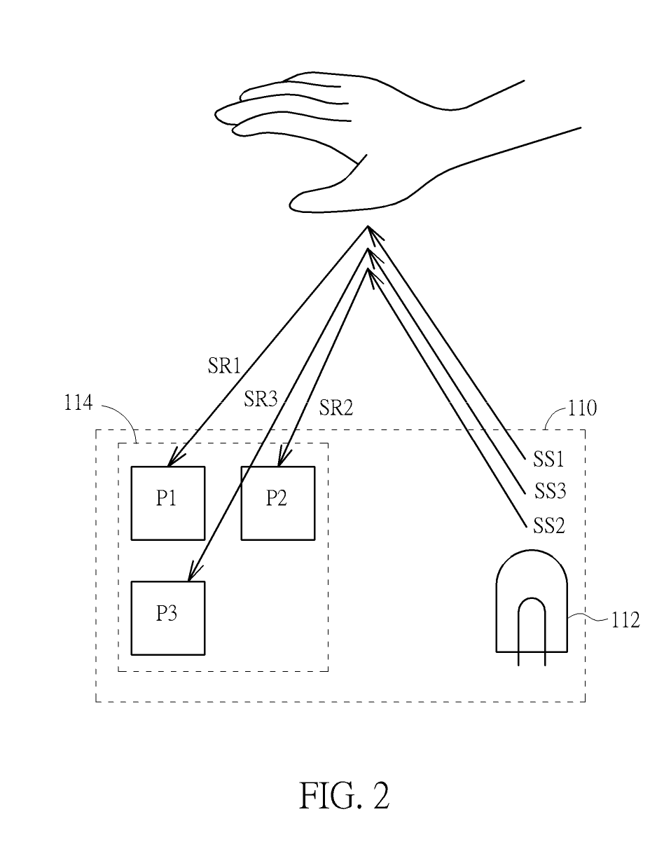

FIG. 2 illustrates an implementation of the optical sensor module 110 shown in FIG. 1. The optical sensor module 110 may include alight source 112 and a sensing device 114, wherein the sensing device 114 may include a plurality of sensors (implemented by a plurality of sensing pixels/photodetectors P1-P3). In this implementation, the light source 112 may emit a plurality of detection signals (light signals) SS1-SS3 to a non-contact object (the user's hand), and the sensing pixels P1-P3 may receive a plurality of reflected signals SR1-SR3 reflected from the non-contact object in response to the detection signals SS1-SS3 respectively, and according generate a plurality of detection results. As the sensing pixels P1-P3 are located at different positions, the reflected signals SR1-SR3 received by the sensing pixels P1-P3 may have different signal waveforms when the user's hand keeps moving. The sensing device 114 may perform a computation (e.g. a cross correlation operation or a phase difference calculation) on the detection results to determine the motion information (e.g. a direction and distance of movement versus time). In an alternative design, the optical sensor module 110 may have a positioning function. For example, the sensing pixels P1-P3 may define/form a geometric plane (i.e. the sensing pixels P1-P3 do not lie on the same straight line). When the light source 112 emits the detection signals SS1-SS3, the sensing pixels P1-P3 may detect the reflected signals SR1-SR3 respectively and accordingly generate the detection results. The sensing device 114 may perform a computation (e.g. a triangulation calculation) on the detection results to detect a position of the user's hand, thereby determining the motion information (e.g. the position of the user's hand versus time).

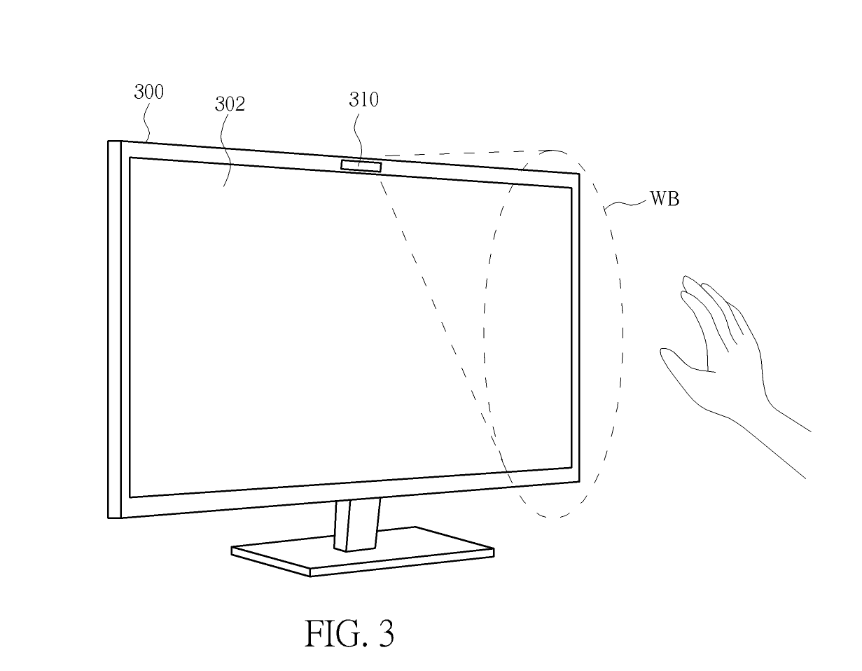

The implementation of the optical sensor module 110 described above is for illustrative purposed only, and is not meant to be a limitation of the present invention. In one implementation, it is possible to implement the optical sensor module 110 by a sensor array. Further, in addition to the upper side of the display surface 102 (an upper frame of the electronic apparatus 100), it is possible to dispose the optical sensor module 110 on the left side, right side, lower side or other locations of the display surface 102. Moreover, a non-contact sensing region provided by the proposed electronic apparatus may not be located in front of an optical sensor module. Please refer to FIG. 3, which is a diagram illustrating an exemplary electronic apparatus according to another embodiment of the present invention. The architecture of the electronic apparatus 300 is based on that of the electronic apparatus 100, wherein the main difference is that a non-contact sensing region WB provided by an optical sensor module 310 may be located (or substantially located) in front of a display surface 302. For example, a sensor field of view of the sensing device 114 and/or an illumination range of the light source 112 shown in FIG. 2 may be adjusted using optical designs (e.g. adjusting a position of an internal device, such as an optical lens, of an optical sensor module) so as to implement the optical sensor module 310 having the non-contact sensing region WB. Please note that the optical sensor module 310 may operate according to the optical sensing mechanism described in the paragraphs directed to FIG. 2. Hence, the user may perform a gesture in front of a center of the display surface 302, which meets user's operating habits.

It should be noted that the proposed electronic apparatus may define a gesture sensitive region within a non-contact sensing region, wherein the proposed electronic apparatus may define an intuitive non-contact gesture according to motion information (e.g. a path or direction of movement) of a non-contact object, which moves between an inside and an outside of the gesture sensitive region, around the electronic apparatus.

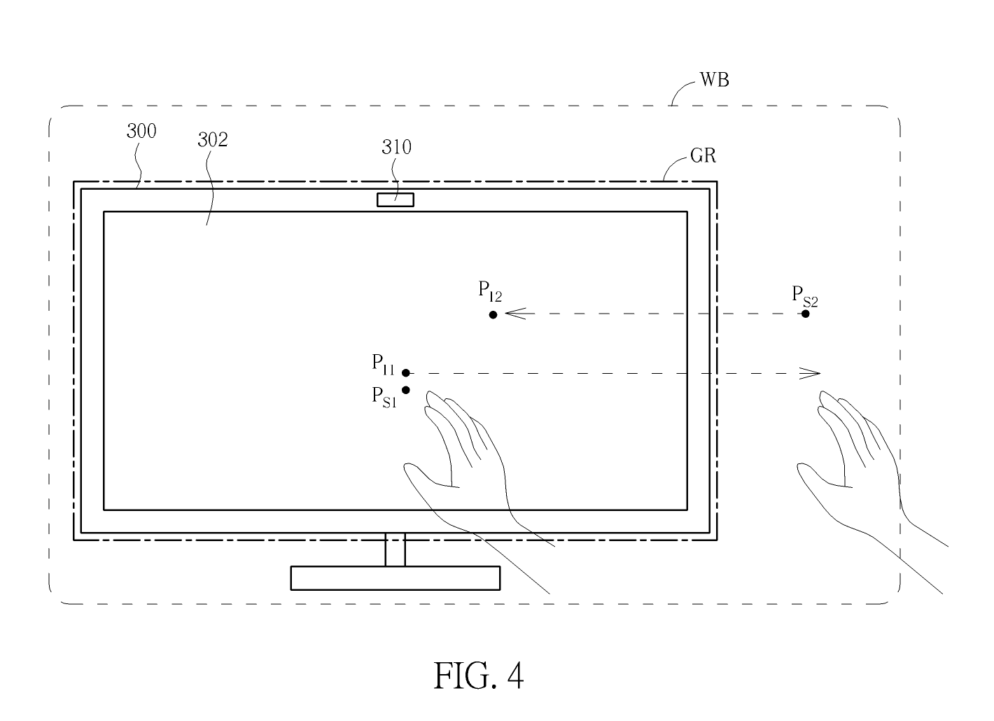

Please refer to FIG. 4 in conjunction with FIG. 3. FIG. 4 is a front view of the electronic apparatus 300 shown in FIG. 3. As shown in FIG. 4, the electronic apparatus 300 may further provide/define a gesture sensitive GR near the display surface 302. Hence, the electronic apparatus 300 (or the optical sensor module 310) may determine motion information (e.g. a path or direction of movement) generated by the user's hand which moves between an inside and an outside of the gesture sensitive region GR, recognize a non-contact gesture corresponding to the user's hand according to the motion information, and enable the electronic apparatus 300 to perform a specific function according to the non-contact gesture. By way of example but not limitation, projection of the gesture sensitive region GR on the display surface 302 may be (or approximate to) the display surface 302. Hence, the user in front of the display surface 302 may determine whether the user's hand passes through an edge of the display surface 302 (or a frame of the electronic apparatus 300) so as to determine whether the user's hand enters/leaves the gesture sensitive region GR.

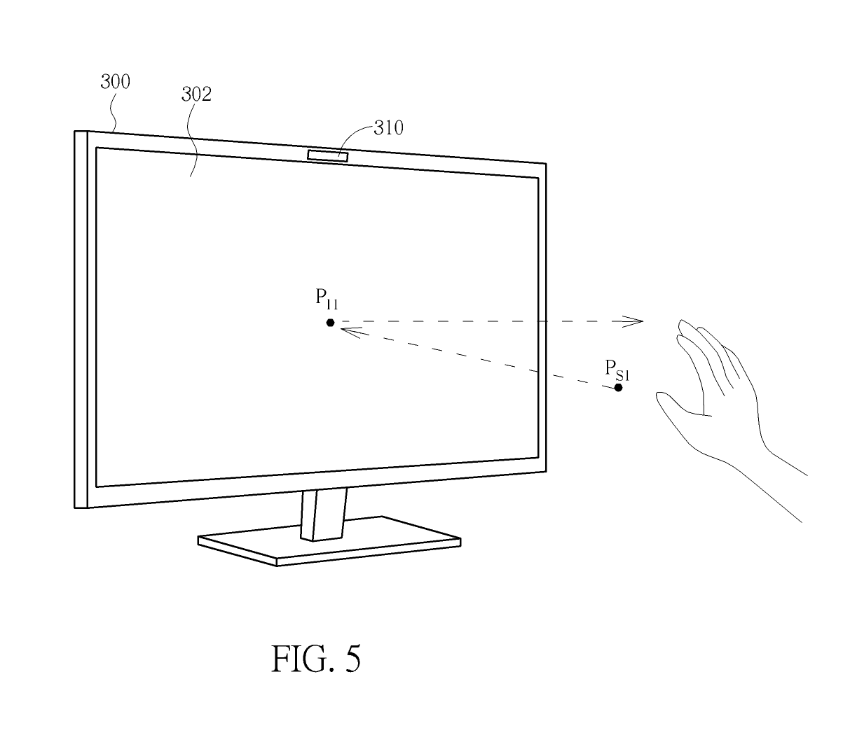

Please refer to FIG. 4 and FIG. 5 together. FIG. 5 is a diagram illustrating control over the electronic apparatus 300 shown in FIG. 3 according to an embodiment of the present invention. Firstly, the user's hand is located at an initial position P_{S1} within the gesture sensitive region GR. Next, the user's hand moves from the initial position P_{S1} toward the display surface 302 and arrives at an intermediate position P_{I1}, wherein a displacement of the user's hand in a vertical direction toward the display surface 302 is greater than a predetermined distance. In other words, projection of a distance traveled by the user's hand (a distance between the initial position P_{S1} and the intermediate position P_{I1}) onto a direction, which is normal to the display surface 302 and passes through the initial position P_{S1}, is greater than the predetermined distance. In one implementation, the user's hand may move from the initial position P_{S1} to the intermediate position P_{I1} in the vertical direction toward the display surface 302, such that the user facing the display surface 302 may see that projection of the initial position P_{S1} on the display surface 302 substantially overlaps with projection of the intermediate position P_{I1} on the display surface 302.

After staying at the intermediate position P_{I1} over a predetermined period of time, the user's hand may move in a direction parallel to the display surface 302 to thereby leave the gesture sensitive region GR through the right side of the display surface 302. When the optical sensor module 310 determines this motion information (e.g. based on the optical sensing mechanism described in the paragraphs directed to FIG. 2), the optical sensor module 310 (or a processing circuit of the electronic apparatus 300; not shown) may recognize that the user performs an approaching and panning gesture. After recognizing the approaching and panning gesture, the optical sensor module 310 (or the processing circuit of the electronic apparatus 300) may enable the electronic apparatus 300 to perform a specific function. By way of example but not limitation, in a case where the electronic apparatus 300 operates in a document/webpage/picture browsing mode, the non-contact gesture shown in FIG. 5 may enable the electronic apparatus 300 to perform a page turning function or a page scrolling function (e.g. scrolling a displayed content from left to right). In another example, when the electronic apparatus 300 executes an item selection command to select a specific item displayed on the display surface 302 (not shown in FIG. 4 and FIG. 5), the non-contact gesture shown in FIG. 5 may enable the electronic apparatus 300 to delete the specific item (e.g. discarding the specific item through the right side of the display surface 302).

It should be noted that different lengths of time the user's hand stays at the intermediate position P_{I1} may correspond to different specific functions. By way of example but not limitation, the optical sensor module 310 may further determine if the user's hand stays at the intermediate position P_{I1} over another predetermined period of time (longer than the predetermined period of time). When a length of time the user's hand stays at the intermediate position P_{I1} is between the predetermined period of time and the another predetermined period of time, the electronic apparatus 300 may perform a first specific function (e.g. moving a displayed content, which is similar to using a mouse to scroll the displayed content) according to the approaching and panning gesture. When the length of time the user's hand stays at the intermediate position P_{I1} is longer than the another predetermined period of time, the electronic apparatus 300 may perform a second specific function different from the first specific function (e.g. moving a selected item, which is similar to using a mouse to drag the selected item) according to the approaching and panning gesture.

The proposed control method of an electronic apparatus may further include the step of initial position detection in order to increase motion detection accuracy and avoid misoperation. For example, in the embodiment shown in FIG. 5, the optical sensor module 310 may detect if the user's hand stays at a specific position over a specific period of time (e.g. according to waveform(s) of reflected signal(s) or a position computation result). When the user's hand stays at the specific position over the specific period of time, the optical sensor module 310 may use the specific position as an initial position of a gesture operation (e.g. the initial position P_{S1}). Next, the optical sensor module 310 may determine motion information generated by the user's hand which moves from the initial position and travels between the inside and the outside of the gesture sensitive region GR.

Although the above description refers to a gesture sensitive region whose projection on a display surface is substantially equal to the display surface, a size and/or location of the gesture sensitive region may be adjusted according to actual requirements. To facilitating an understanding of the present invention, the proposed control mechanism of an electronic apparatus is described with reference to the gesture sensitive region GR shown in FIG. 4 in the following. However, this is not meant to be a limitation of the present invention.

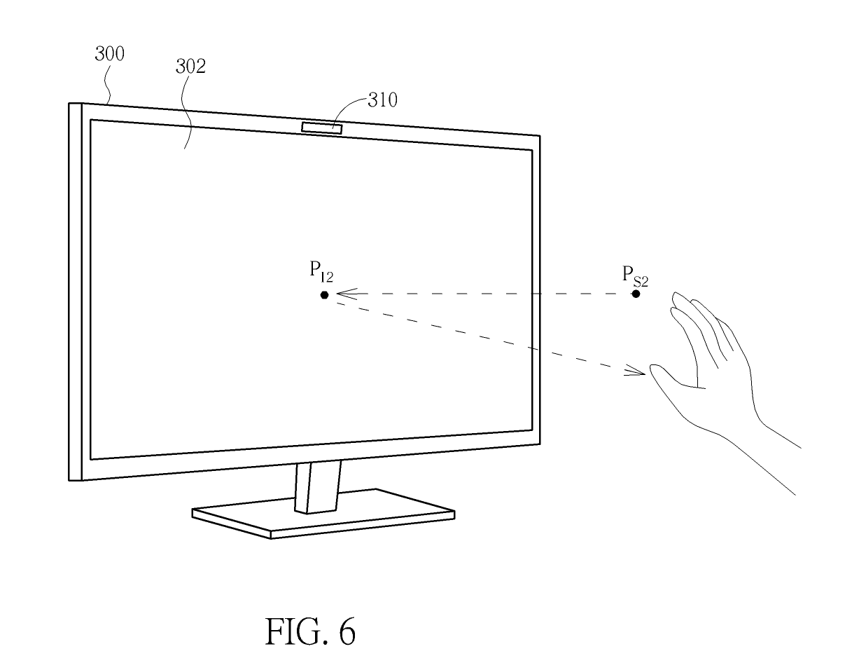

Please refer to FIG. 4 and FIG. 6 together. FIG. 6 is a diagram illustrating control over the electronic apparatus 300 shown in FIG. 3 according to another embodiment of the present invention. The user's hand moves from an initial position P_{S2} outside the gesture sensitive region GR in a direction parallel to the display surface 302, enters the gesture sensitive region GR through the right side of the display surface 302, and arrives at an intermediate position P_{I2} within the gesture sensitive region GR. After staying at the intermediate position P_{I2} over a predetermined period of time, the user's hand moves from the intermediate position P_{I2} in a direction away from the display surface 302, wherein a displacement of the user's hand in a vertical direction away from the display surface 302 is greater than a predetermined distance. In other words, projection of a distance from the intermediate position P_{I2} traveled by the user's hand onto a direction, which is normal to the display surface 302 and passes through the intermediate position P_{I2}, is greater than the predetermined distance. In one implementation, the user's hand may move away from the intermediate position P_{I2} in a vertical direction away from the display surface 302 directly.

When the optical sensor module 310 determines the aforementioned motion information (e.g. based on the optical sensing mechanism described in the paragraphs directed to FIG. 2), the optical sensor module 310 (or a processing circuit of the electronic apparatus 300; not shown) may recognize that the user performs a panning and receding gesture. After recognizing the panning and receding gesture, the optical sensor module 310 (or the processing circuit of the electronic apparatus 300) may enable the electronic apparatus 300 to perform a specific function. By way of example but not limitation, the non-contact gesture shown in FIG. 6 may enable the electronic apparatus 300 to perform a quick menu accessing function.

Similarly, the control method involved in the electronic apparatus 300 shown in FIG. 6 may further include the step of initial position detection in order to increase motion detection accuracy and avoid misoperation. For example, the optical sensor module 310 may detect if the user's hand stays at a specific position over a specific period of time. When the user's hand stays at the specific position over the specific period of time, the optical sensor module 310 may use the specific position as an initial position of a gesture operation (e.g. the initial position P_{S2}). Next, the optical sensor module 310 may determine motion information generated by the user's hand which moves from the initial position and travels between the inside and the outside of the gesture sensitive region GR.

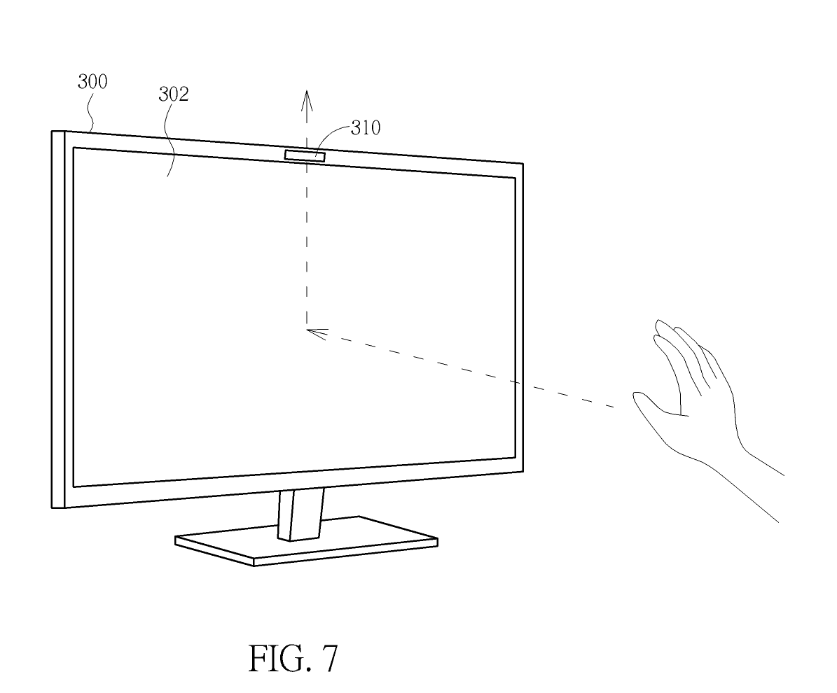

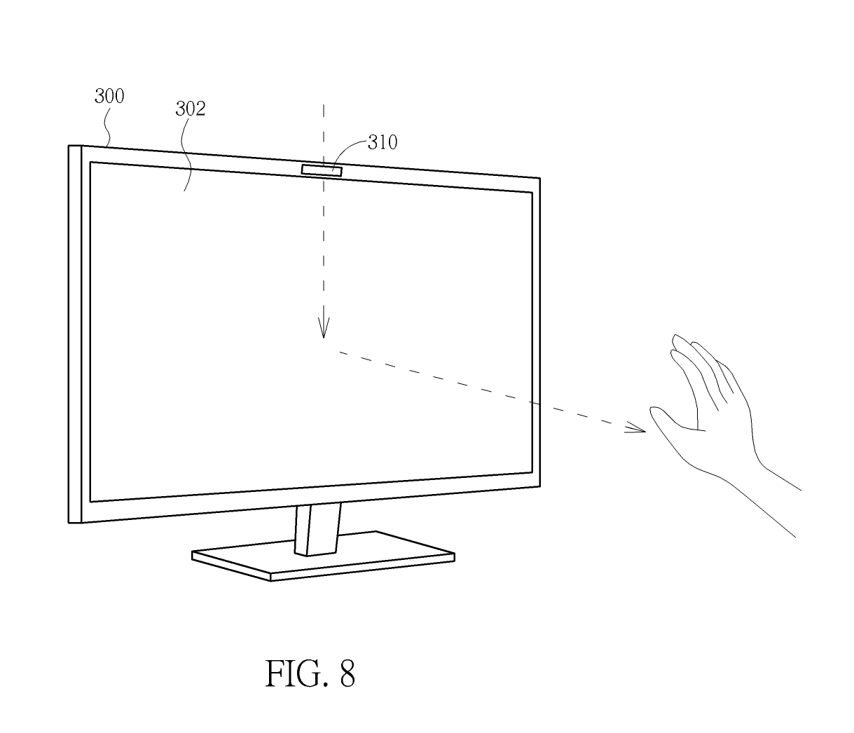

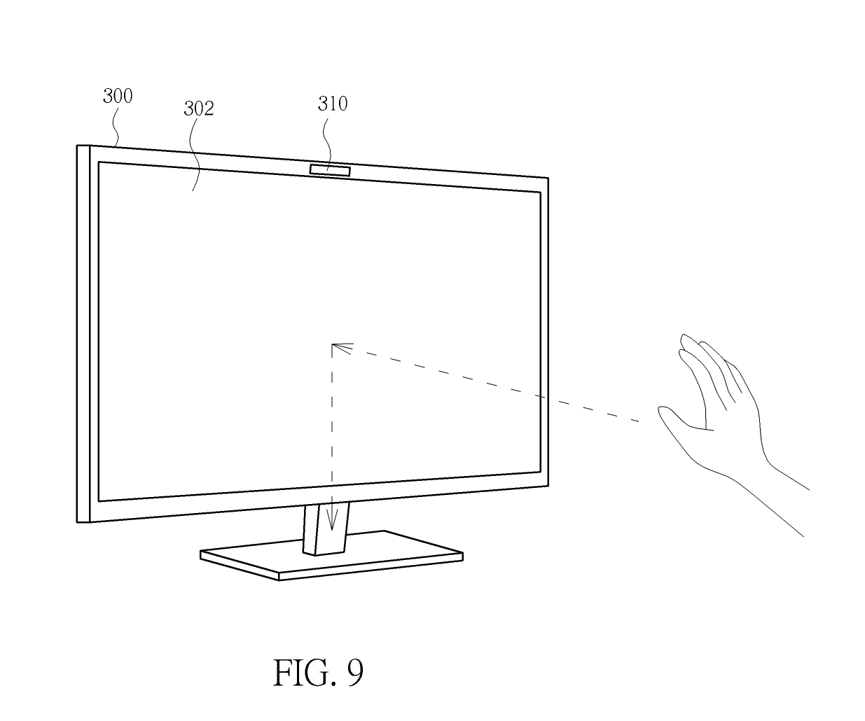

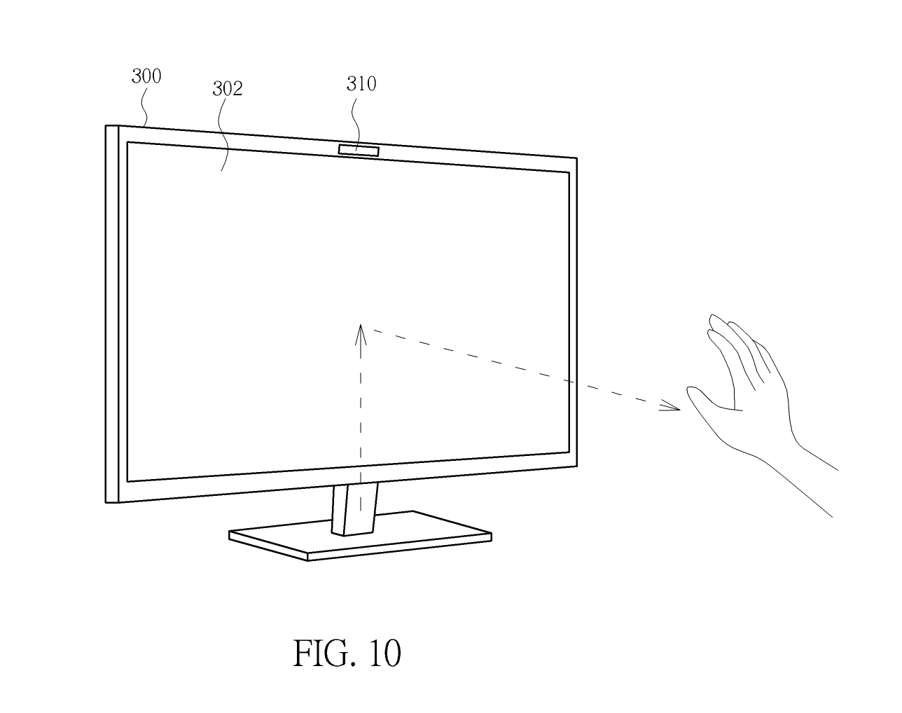

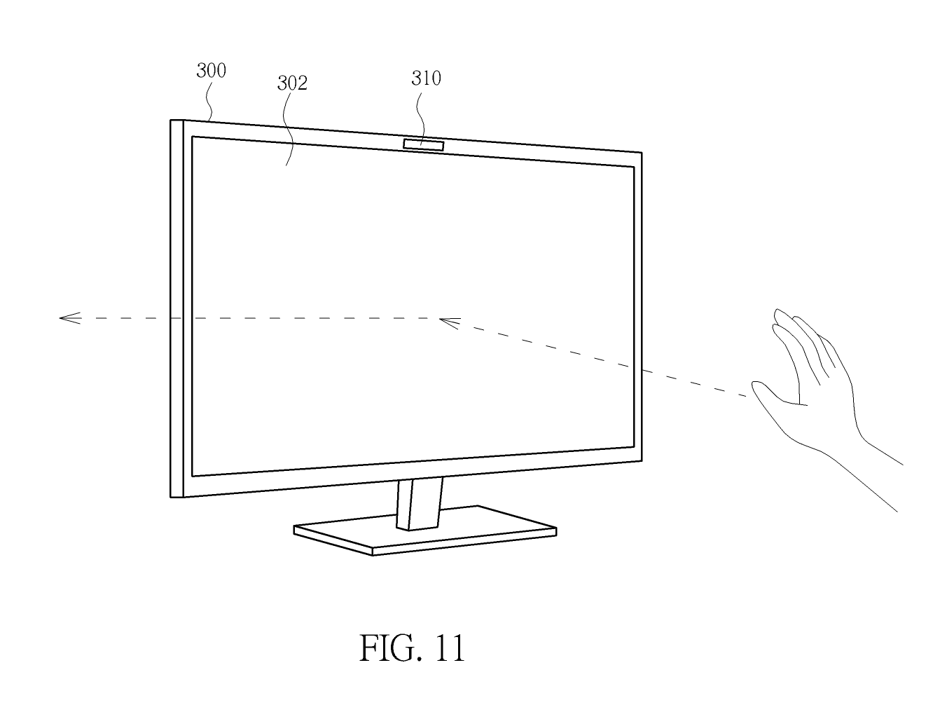

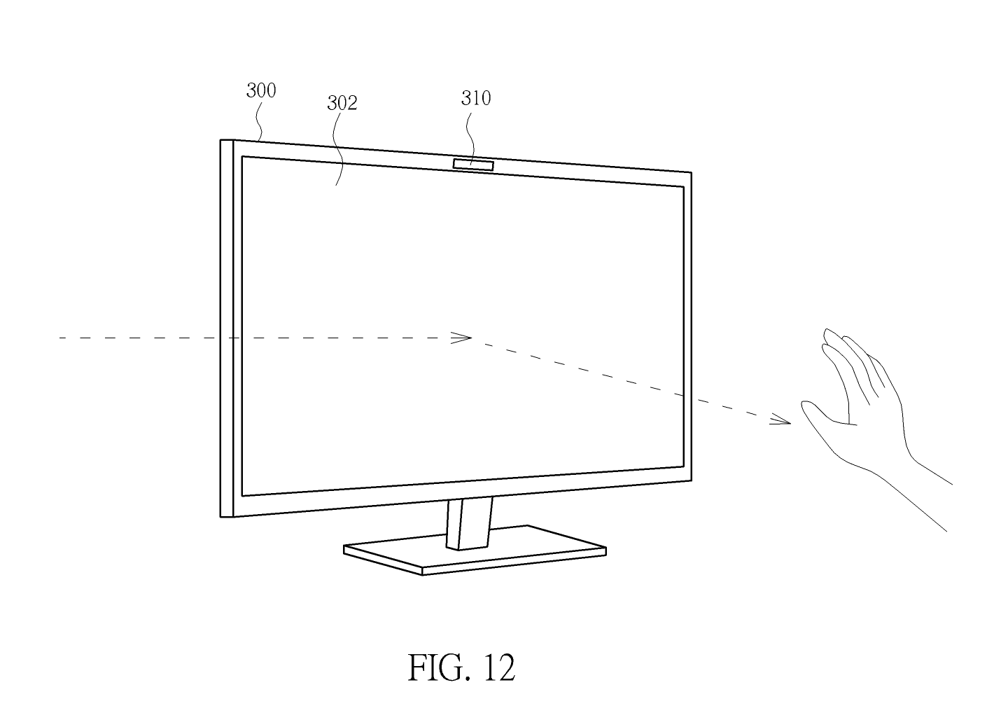

FIG. 7, FIG. 9 and FIG. 11 are diagrams illustrating exemplary approaching and panning gestures each having different directions of panning according to embodiments of the present invention. As a person skilled in the art should understand operations of non-contact gestures shown in FIG. 7, FIG. 9 and FIG. 11 after reading the paragraphs directed to FIGS. 1-5, further description is omitted here for brevity. FIG. 8, FIG. 10 and FIG. 12 are diagrams illustrating exemplary panning and receding gestures each having different directions of panning according to embodiments of the present invention. As a person skilled in the art should understand operations of non-contact gestures shown in FIG. 8, FIG. 10 and FIG. 12 after reading the paragraphs directed to FIGS. 1-6, further description is omitted here for brevity.

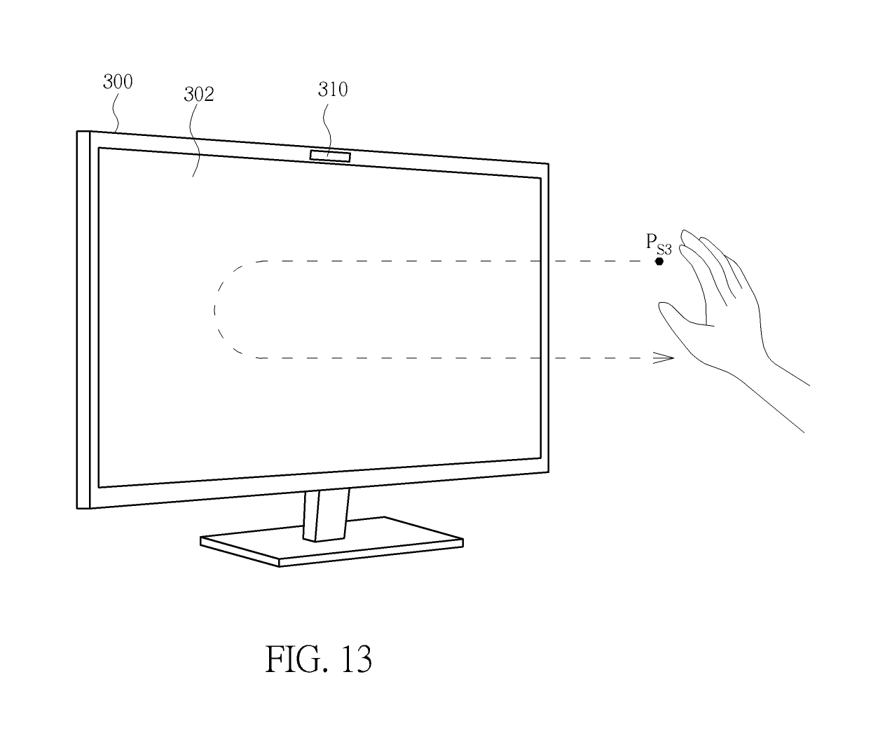

When the user's hand enters and leaves a gesture sensitive region through the same side thereof within a predetermined period of time, a non-contact rotation gesture may be triggered to enable an electronic apparatus to perform a specific function accordingly. Please refer to FIG. 4 and FIG. 13 together. FIG. 13 is a diagram illustrating control over the electronic apparatus 300 shown in FIG. 3 according to another embodiment of the present invention. Firstly, the user's hand is located at an initial position P_{S3} outside the gesture sensitive region GR. Next, the user's hand enters the gesture sensitive region GR through the right side of the gesture sensitive region GR (or the display surface 302), and leaves the gesture sensitive region GR through the right side of the gesture sensitive region GR (or the display surface 302) after entering the gesture sensitive region GR. When the optical sensor module 310 detects that the aforementioned movements (e.g. successive movements) are completed within a predetermined period of time (e.g. based on the optical sensing mechanism described in the paragraphs directed to FIG. 2), the optical sensor module 310 may refer to the motion information to recognize that the user performs a rotation gesture, wherein the motion information may be determined according to waveform(s) of reflected signal(s) or a position computation result.

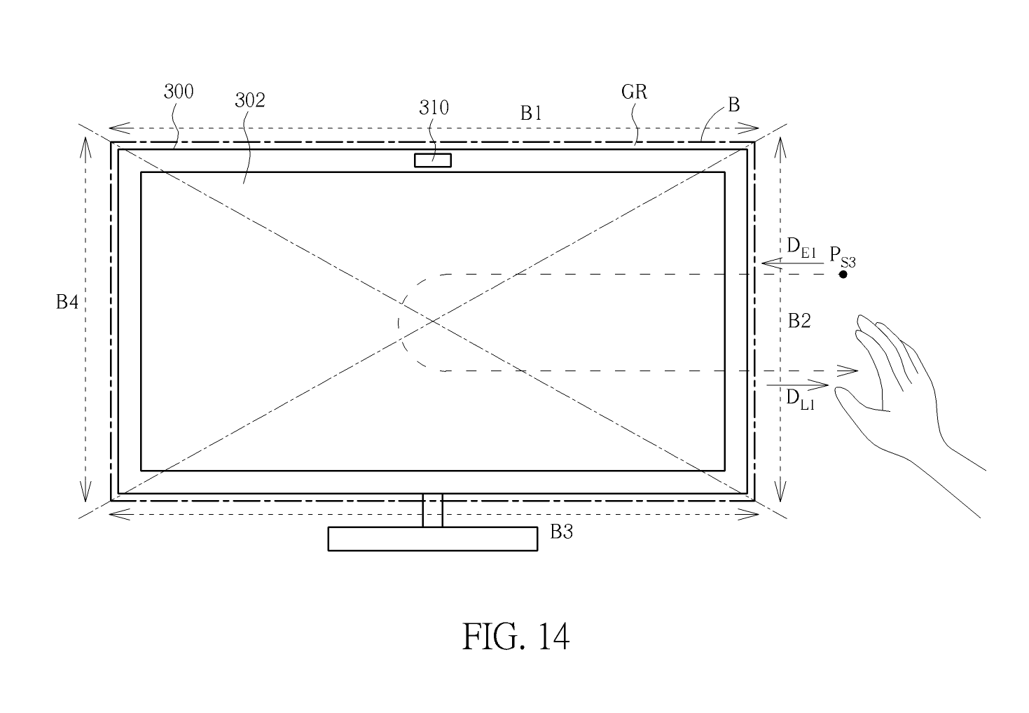

In one implementation, the gesture sensitive region GR may be divided into a plurality of sub-regions, wherein the optical sensor module 310 may accordingly determine whether the use's hand enters and leaves through the same side of the gesture sensitive region GR. Please refer to FIG. 14, which is an implementation of the gesture sensitive region of the electronic apparatus 300 shown in FIG. 13. In this implementation, a boundary BD of the gesture sensitive region GR may be divided into a plurality of sub-boundaries B1-B4. Hence, when the user's hand completes the following movements within a predetermined period of time, the optical sensor module 310 may refer to the corresponding motion information to recognize that the user performs a rotation gesture: enter the gesture sensitive region GR through a sub-boundary (e.g. a sub-boundary B2) of the sub-boundaries B1-B4 from the initial position P_{S3} outside the gesture sensitive region GR; and leave the gesture sensitive region GR through the sub-boundary of the sub-boundaries B1-B4 after entering the gesture sensitive region GR. In this implementation, the aforementioned motion information may be determined according to waveform(s) of reflected signal(s) or a position computation result.

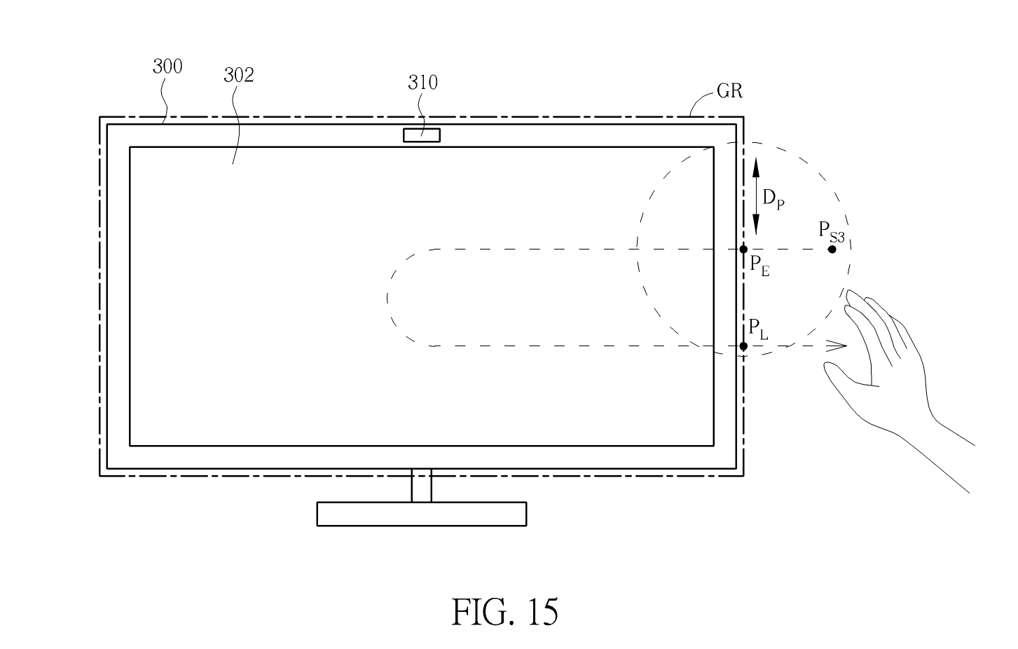

In another implementation, the proposed control mechanism of an electronic apparatus may refer to respective positions where the user's hand enters and leaves a gesture sensitive region to thereby determine whether the user's hand enters and leaves the gesture sensitive region through the same side thereof. Please refer to FIG. 15, which is another implementation of the gesture sensitive region of the electronic apparatus 300 shown in FIG. 13. In this implementation, the gesture sensitive region GR has a boundary BD. When the user's hand completes the following movements within a predetermined period of time, the optical sensor module 310 may refer to the corresponding motion information to recognize that the user performs a rotation gesture: enter the gesture sensitive region GR through a first position P_{E} on the boundary BD from the initial position P_{S3} outside the gesture sensitive region GR; and leave the gesture sensitive region GR through a second position P_{L} on the boundary BD after entering the gesture sensitive region GR, wherein a distance between the second position P_{L} and the first position P_{E} is less than a predetermined distance D_{P}. In other words, in a case where the user's hand enters the gesture sensitive region GR through the first position P_{E}, as long as the user's hand leaves the gesture sensitive region GR through a sphere having a center at the first position P_{E} and a radius equal to the predetermined distance D_{P}, the user's hand may be regarded as entering and leaving through the same side of the gesture sensitive region GR.

After recognizing the rotation gesture, the optical sensor module 310 (or a processing circuit of the electronic apparatus 300; not shown) may enable the electronic apparatus 300 to perform a specific function. By way of example but not limitation, the non-contact gesture shown in FIG. 13 may enable the electronic apparatus 300 to perform an item rotating function or a displayed content rotating function (e.g. rotating an item or a displayed content by a predetermined angle).

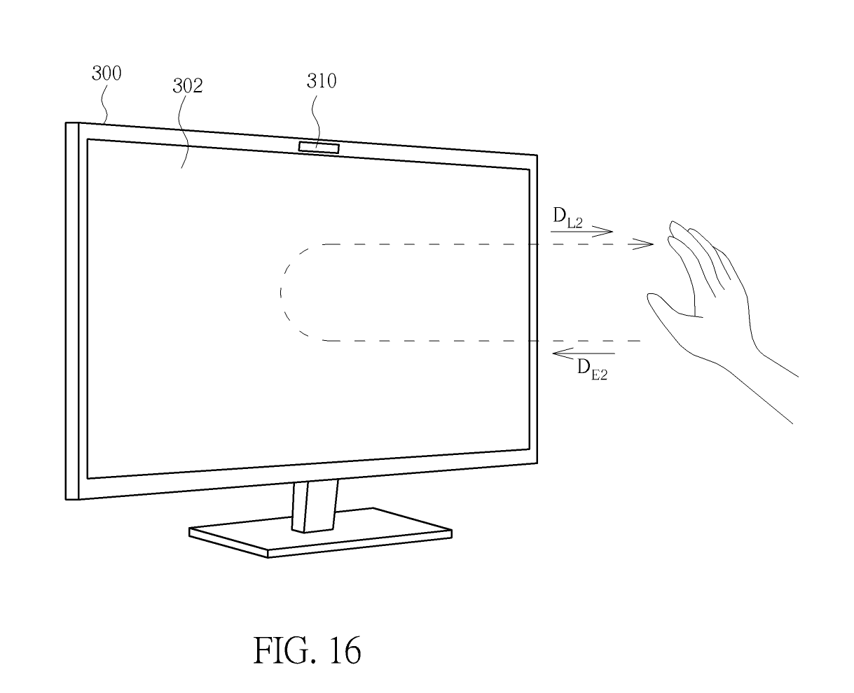

It should be noted that, when the motion information determined by the optical sensor 310 indicates that a direction of rotation of the user's hand in a reference plane parallel to the display surface 302 is a clockwise direction, the rotation gesture is a clockwise rotation gesture. When the direction of rotation of the user's hand in reference the plane parallel to the display surface 302 is a counterclockwise direction, the rotation gesture is a counterclockwise rotation gesture. In one implementation, the optical sensor 310 may determine a direction of the rotation gesture according to respective directions in which user's hand enters and leaves the gesture sensitive region GR. For example, in the embodiment shown in FIG. 14, the user's hand enters the gesture sensitive region GR in a first direction D_{E1}, leaves the gesture sensitive region GR in a second direction D_{L1}. As projection of a direction in which the first direction D_{E1} rotates to the second direction D_{L1} on the display surface 302 is a counterclockwise direction (i.e. the user's hand rotates counterclockwise), the motion information indicates that a direction of rotation of the user's hand in a reference plane parallel to the display surface 302 is a counterclockwise direction (a corresponding rotation gesture is a counterclockwise rotation gesture). In the embodiment shown in FIG. 16, the user's hand enters the gesture sensitive region GR in a first direction D_{E2}, leaves the gesture sensitive region GR in a second direction D_{L2}. As projection of a direction in which the first direction D_{E2} rotates to the second direction D_{L2} on the display surface 302 is a clockwise direction (i.e. the user's hand rotates clockwise), the motion information indicates that a direction of rotation of the user's hand in a reference plane parallel to the display surface 302 is a clockwise direction (a corresponding rotation gesture is a clockwise rotation gesture).

In an alternative design, a rotation of direction of the user's hand may be determined according to waveform variations of reflected signals received by an optical sensor module. For example, in a case where the optical sensor module 310 shown in FIG. 13 is implemented by the optical sensor module 110 shown in FIG. 2, the optical sensor module 110 may determine refer to respective detection results generated by the sensing pixels P1-P3 to determine when respective peaks of the reflected signals SR1-SR3 occur. In the implementation shown in FIG. 13, as a direction of rotation of the user's hand in a reference plane parallel to the display surface 302 is a counterclockwise direction, the respective peaks of the reflected signals SR1-SR3 occur in a first predetermined sequence (e.g. the peak of the reflected signal SR2 occurs first, followed by the peak of the reflected signal SR1, and finally the peak of the reflected signal SR3). The motion information determined by the optical sensor module 110 may indicate that the direction of rotation of the user's hand in the reference plane parallel to the display surface is the counterclockwise direction. Additionally, when the respective peaks of the reflected signals SR1-SR3 occur in a second predetermined sequence different from the first predetermined sequence (e.g. the peak of the reflected signal SR3 occurs first, followed by the peak of the reflected signal SR1, and finally the peak of the reflected signal SR2), the motion information determined by the optical sensor module 110 may indicate that the direction of rotation of the user's hand in the reference plane parallel to the display surface is the clockwise direction (e.g. the implementation shown in FIG. 16).

Similarly, the control methods involved in the electronic apparatuses shown in FIG. 13 and FIG. 16 may further include the step of initial position detection in order to increase motion detection accuracy and avoid misoperation. For example, in the embodiment shown in FIG. 13, the optical sensor module 310 may detect if the user's hand stays at a specific position over a specific period of time. When the user's hand stays at the specific position over the specific period of time, the optical sensor module 310 may use the specific position as an initial position of a gesture operation (e.g. the initial position P_{S3}). Next, the optical sensor module 310 may determine motion information generated by the user's hand which moves from the initial position and travels between the inside and the outside of the gesture sensitive region GR.

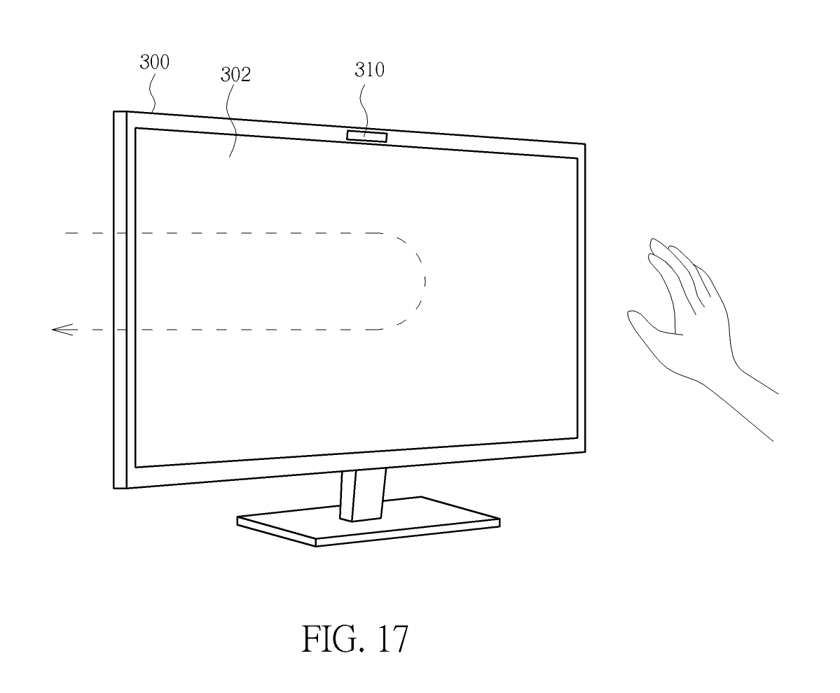

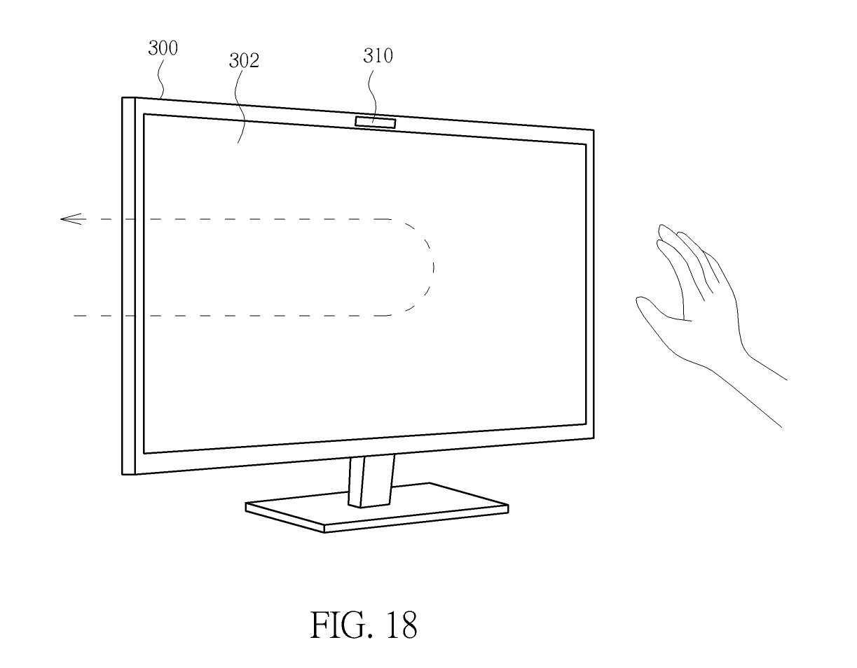

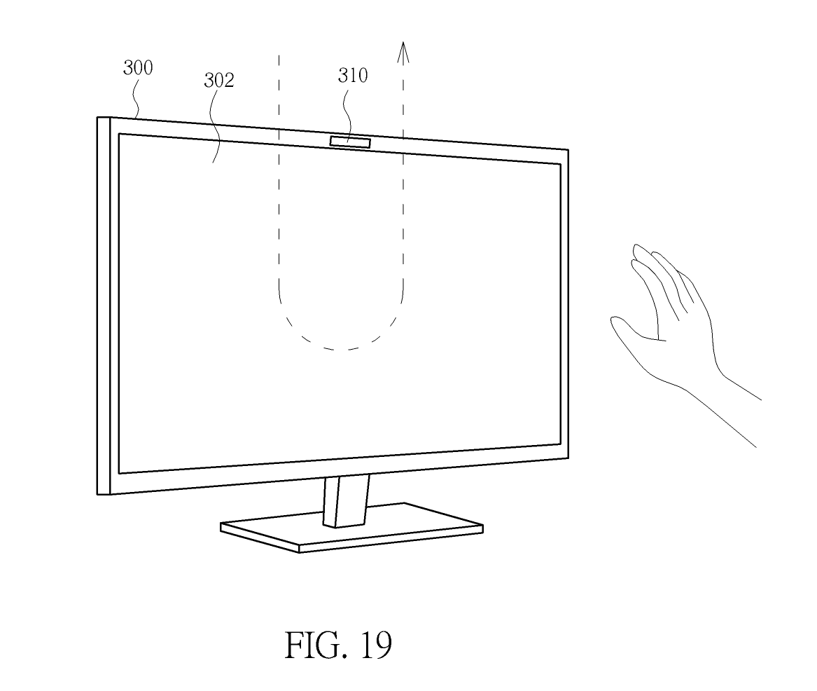

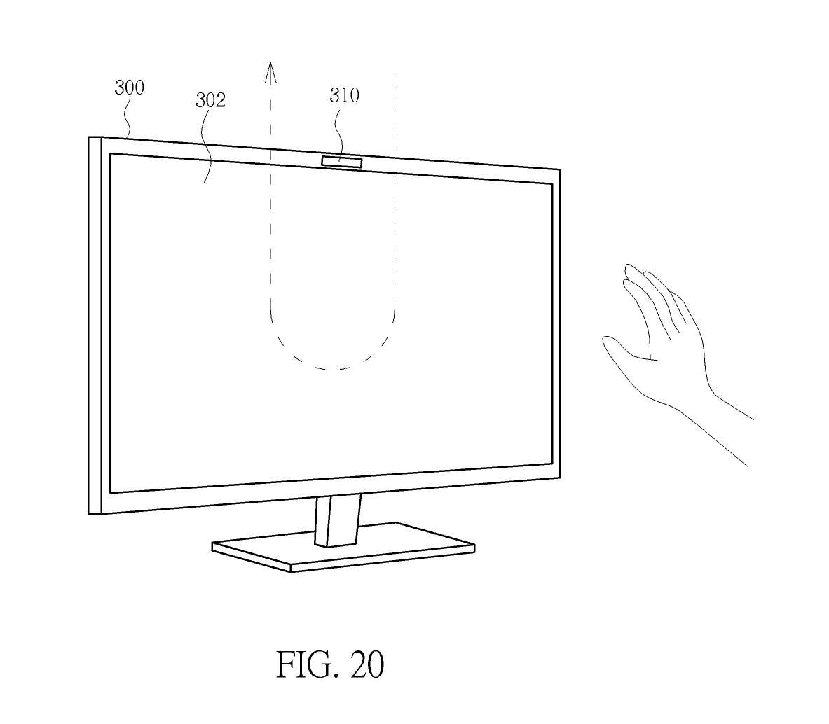

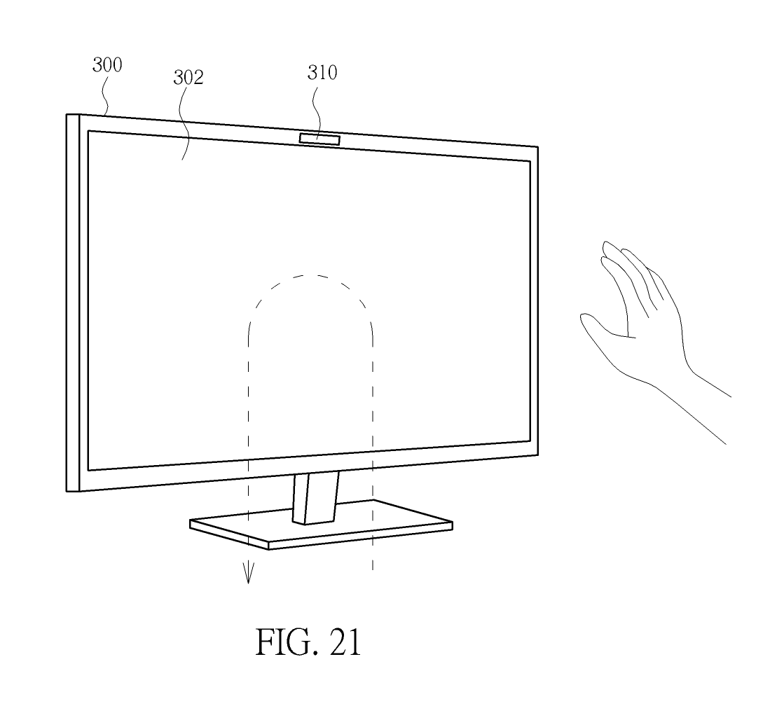

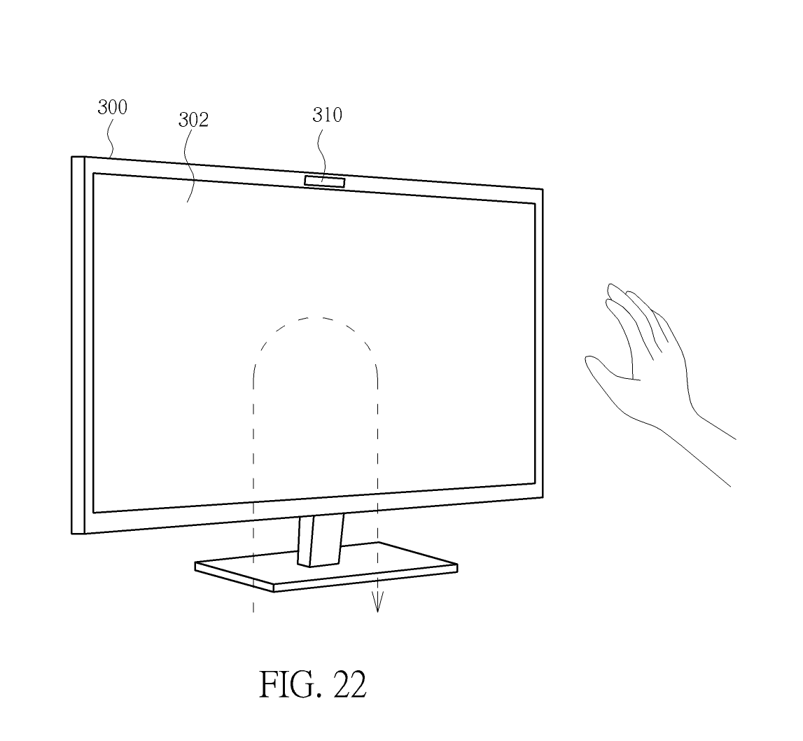

FIGS. 17-22 are diagrams illustrating different rotation gestures according to embodiments of the present invention. As a person skilled in the art should understand operations of non-contact gestures shown in FIGS. 17-22 after reading the paragraphs directed to FIGS. 1-16, further description is omitted here for brevity. In addition, although the above description refers to the electronic apparatus 300 shown in FIG. 3 (the corresponding non-contact sensing region WB is located in front of the display surface 302), a person skilled in the art should understand that the proposed control method of an electronic apparatus may be employed in the electronic apparatus 100 shown in FIG. 1 (the corresponding non-contact sensing region WA is directly located in front of the optical sensor module 110).

To sum up, the proposed control method of an electronic apparatus can not only provide non-contact human-computer interaction but also meet requirements of various and intuitive non-contact gestures.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an electronic apparatus, the electronic apparatus comprising a display surface, the electronic apparatus providing a gesture sensitive region near the display surface, the control method comprising:
determining motion information of a non-contact object around the electronic apparatus, wherein the non-contact object moves between an inside and an outside of the gesture sensitive region to generate the motion information;
recognizing a non-contact gesture corresponding to the non-contact object according to the motion information; and
enabling the electronic apparatus to perform a specific function according to the non-contact gesture.

2. The control method of claim 1, wherein the step of determining the motion information of the non-contact object around the electronic apparatus comprises:
generating a plurality of detection signals to the non-contact object;
receiving a plurality of reflected signals reflected from the non-contact object in response to the detection signals, respectively, and accordingly generating a plurality of detection results; and
performing a computation on the detection results to determine the motion information.

3. The control method of claim 1, wherein when the motion information indicates the following information:
the non-contact object moves from an initial position within the gesture sensitive region toward the display surface and arrives at an intermediate position, wherein a displacement of the non-contact object in a vertical direction toward the display surface is greater than a predetermined distance;
the non-contact object stays at the intermediate position over a predetermined period of time; and
the non-contact object leaves the gesture sensitive region from the intermediate position in a direction parallel to the display surface;
the non-contact gesture is an approaching and panning gesture.

4. The control method of claim 3, wherein the step of determining the motion information of the non-contact object around the electronic apparatus comprises:
detecting if the non-contact object stays at a specific position over a specific period of time;
when the non-contact object stays at the specific position over the specific period of time, using the specific position as the initial position; and
determining the motion information generated by the non-contact object which moves from the initial position and travels between the inside and the outside of the gesture sensitive region.

5. The control method of claim 3, wherein the step of enabling the electronic apparatus to perform the specific function according to the non-contact gesture comprises:
enabling the electronic apparatus to perform a page turning function or a page scrolling function according to the approaching and panning gesture.

6. The control method of claim 3, wherein the electronic apparatus executes an item selection command to select a specific item, the step of enabling the electronic apparatus to perform the specific function according to the non-contact gesture comprises:
enabling the electronic apparatus to delete the specific item according to the approaching and panning gesture.

7. The control method of claim 1, wherein when the motion information indicates the following information:
the non-contact object moves from an initial position outside the gesture sensitive region in a direction parallel to the display surface, enters the gesture sensitive region and arrives at an intermediate position within the gesture sensitive region
the non-contact object stays at the intermediate position over a predetermined period of time; and
the non-contact object moves from the intermediate position in a direction away from the display surface, wherein a displacement of the non-contact object in a vertical direction away from the display surface is greater than a predetermined distance;
the non-contact gesture is a panning and receding gesture.

8. The control method of claim 7, wherein the step of determining the motion information of the non-contact object around the electronic apparatus comprises:
detecting if the non-contact object stays at a specific position over a specific period of time;
when the non-contact object stays at the specific position over the specific period of time, using the specific position as the initial position; and
determining the motion information generated by the non-contact object which moves from the initial position and travels between the inside and the outside of the gesture sensitive region.

9. The control method of claim 7, wherein the step of enabling the electronic apparatus to perform the specific function according to the non-contact gesture comprises:
enabling the electronic apparatus to perform a quick menu accessing function according to the panning and receding gesture.

10. The control method of claim 1, wherein the gesture sensitive region has a boundary, the boundary is divided into a plurality of sub-boundaries; and when the motion information indicates that the non-contact object completes the following movements within a predetermined period of time:
entering the gesture sensitive region through a sub-boundary of the sub-boundaries from an initial position outside the gesture sensitive region; and
leaving the gesture sensitive region through the sub-boundary of the sub-boundaries after entering the gesture sensitive region;
the non-contact gesture is a rotation gesture.

11. The control method of claim 10, wherein the step of determining the motion information of the non-contact object around the electronic apparatus comprises:
detecting if the non-contact object stays at a specific position over a specific period of time;
when the non-contact object stays at the specific position over the specific period of time, using the specific position as the initial position; and
determining the motion information generated by the non-contact object which moves from the initial position and travels between the inside and the outside of the gesture sensitive region.

12. The control method of claim 10, wherein the step of enabling the electronic apparatus to perform the specific function according to the non-contact gesture comprises:
enabling the electronic apparatus to perform an item rotating function or a displayed content rotating function according to the rotation gesture.

13. The control method of claim 10, wherein when the motion information indicates that a direction of rotation of the non-contact object in a reference plane parallel to the display surface is a clockwise direction, the rotation gesture is a clockwise rotation gesture; and when the direction of rotation of the non-contact object in the reference plane parallel to the display surface is a counterclockwise direction, the rotation gesture is a counterclockwise rotation gesture.

14. The control method of claim 10, wherein the non-contact object enters the gesture sensitive region in a first direction, leaves the gesture sensitive region in a second direction; when projection of a direction in which the first direction rotates to the second direction on the display surface is the clockwise direction, the motion information indicates that the direction of rotation of the non-contact object in a reference plane parallel to the display surface is the clockwise direction; and when projection of the direction in which the first direction rotates to the second direction on the display surface is the counterclockwise direction, the motion information indicates that the direction of rotation of the non-contact object in the reference plane parallel to the display surface is the counterclockwise direction.

15. The control method of claim 10, wherein the electronic apparatus comprises an optical sensor module, the optical sensor module comprises a first sensor, a second sensor and a third sensor; the first sensor, the second sensor and the third sensor form a predetermined plane; and the step of determining the motion information of the non-contact object around the electronic apparatus comprises:
generating a first detection signal, a second detection signal and a third detection signal to the non-contact object;
utilizing the first sensor, the second sensor and the third sensor to receive a first reflected signal, a second reflected signal and a third reflected signal reflected from the non-contact object in response to the first detection signal, the second detection signal and the third detection signal, respectively, and accordingly generating a first detection result, a second detection result and a third detection result respectively; and
referring to the first detection result, the second detection result and the third detection result to determine when respective peaks of the first reflected signal, the second reflected signal and the third reflected signal occur;
wherein when the respective peaks of the first reflected signal, the second reflected signal and the third reflected signal occur in a first predetermined sequence, the motion information indicates that the direction of rotation of the non-contact object in a reference plane parallel to the display surface is the clockwise direction; and when the respective peaks of the first reflected signal, the second reflected signal and the third reflected signal occur in a second predetermined sequence different from the first predetermined sequence, the motion information indicates that the direction of rotation of the non-contact object in the reference plane parallel to the display surface is the counterclockwise direction.

16. The control method of claim 1, wherein the gesture sensitive region has a boundary; and when the motion information indicates that the non-contact object completes the following movements within a predetermined period of time:
entering the gesture sensitive region through a first position on the boundary from an initial position outside the gesture sensitive region; and
leaving the gesture sensitive region through a second position on the boundary after entering the gesture sensitive region, wherein a distance between the second position and the first position is less than a predetermined distance;
the non-contact gesture is a rotation gesture.

17. The control method of claim 16, wherein the step of determining the motion information of the non-contact object around the electronic apparatus comprises:
detecting if the non-contact object stays at a specific position over a specific period of time;
when the non-contact object stays at the specific position over the specific period of time, using the specific position as the initial position; and
determining the motion information generated by the non-contact object which moves from the initial position and travels between the inside and the outside of the gesture sensitive region.

18. The control method of claim 16, wherein the step of enabling the electronic apparatus to perform the specific function according to the non-contact gesture comprises:
enabling the electronic apparatus to perform an item rotating function or a displayed content rotating function according to the rotation gesture.

19. The control method of claim 16, wherein when the motion information indicates that a direction of rotation of the non-contact object in a reference plane parallel to the display surface is a clockwise direction, the rotation gesture is a clockwise rotation gesture; and when the direction of rotation of the non-contact object in the reference plane parallel to the display surface is a counterclockwise direction, the rotation gesture is a counterclockwise rotation gesture.

20. The control method of claim 19, wherein the non-contact object enters the gesture sensitive region in a first direction, leaves the gesture sensitive region in a second direction; when projection of a direction in which the first direction rotates to the second direction on the display surface is the clockwise direction, the motion information indicates that the direction of rotation of the non-contact object in the reference plane parallel to the display surface is the clockwise direction; and when projection of the direction in which the first direction rotates to the second direction on the display surface is the counterclockwise direction, the motion information indicates that the direction of rotation of the non-contact object in the reference plane parallel to the display surface is the counterclockwise direction.

21. The control method of claim 19, wherein the electronic apparatus comprises an optical sensor module, the optical sensor module comprises a first sensor, a second sensor and a third sensor; the first sensor, the second sensor and the third sensor form a predetermined plane; and the step of determining the motion information of the non-contact object around the electronic apparatus comprises:
generating a first detection signal, a second detection signal and a third detection signal to the non-contact object;
utilizing the first sensor, the second sensor and the third sensor to receive a first reflected signal, a second reflected signal and a third reflected signal reflected from the non-contact object in response to the first detection signal, the second detection signal and the third detection signal, respectively, and accordingly generating a first detection result, a second detection result and a third detection result respectively; and
referring to the first detection result, the second detection result and the third detection result to determine when respective peaks of the first reflected signal, the second reflected signal and the third reflected signal occur;
wherein when the respective peaks of the first reflected signal, the second reflected signal and the third reflected signal occur in a first predetermined sequence, the motion information indicates that the direction of rotation of the non-contact object in the reference plane parallel to the display surface is the clockwise direction; and when the respective peaks of the first reflected signal, the second reflected signal and the third reflected signal occur in a second predetermined sequence different from the first predetermined sequence, the motion information indicates that the direction of rotation of the non-contact object in the reference plane parallel to the display surface is the counterclockwise direction.
